(19) United States
(12) Patent Application Publication
(10) Pub. No.: US 2026/0291605 A1
(43) Pub. Date: Sep. 24, 2026

(54) Methods And Devices For Denoising Optical Time-Domain Reflectometry Signals

(71) Applicant: EXFO Inc., Quebec (CA)

(72) Inventors: Jonathan PLANTE, Montreal (CA); Renaud LESPERANCE, Montreal (CA); Ludovik MONDOU, Saint-Eustache (CA)

(21) Appl. No.: 19/020,808

(22) Filed: Jan. 14, 2025

Related U.S. Application Data
(60) Provisional application No. 63/565,720, filed on Mar. 15, 2024.
(60) Provisional application No. 63/686,587, filed on Aug. 23, 2024.

(51) Int. Cl. H04B 10/071; G01M 11/00

(52) U.S. Cl. CPC H04B 10/071; G01M 11/3145

(57) ABSTRACT

Example embodiments relate to methods and devices for denoising optical time-domain reflectometry signals. One example embodiment includes a method. The method includes receiving, by a computing device, a plurality of optical time-domain reflectometry (OTDR) traces. The OTDR traces represent backscatter from respective light pulses propagated through an optical fiber. The method also includes calculating, by the computing device based on the plurality of OTDR traces, a mean OTDR trace. Additionally, the method includes determining, by the computing device using a machine-learned model, a set of correction factors. The correction factors represent point-wise modifications that, when applied to the mean OTDR trace, produce a denoised mean OTDR trace. The correction factors are determined based on the plurality of OTDR traces.

### CROSS-REFERENCE TO RELATED APPLICATIONS

The present application claims the benefit of U.S. Provisional Patent Application No. 63/565,720, filed Mar. 15, 2024, and U.S. Provisional Patent Application No. 63/686,587, filed Aug. 23, 2024; the contents of each of which are hereby incorporated by reference in their entireties.

### BACKGROUND

Optical fibers are optical components that transmit electromagnetic signals from one end to another using total internal reflection. They can be made of glass or plastic and are widely used in telecommunications, lasers, and sensors.

The manufacturing process of optical fibers can produce small fluctuations in the optical fiber structure along any segment of optical fiber. One way of identifying such fluctuations is performing optical time-domain reflectometry (OTDR) measurements. When such fluctuations in the optical fiber interact with the OTDR test pulses, interferences and modulations occur. These interferences and modulations produce a backscattering pattern that is usable to analyze the optical fiber.

### SUMMARY

The specification and drawings disclose embodiments that relate to methods and devices for denoising OTDR signals.

In a first aspect, the disclosure describes a method. The method includes receiving, by a computing device, a plurality of OTDR traces. The OTDR traces represent backscatter from respective light pulses propagated through an optical fiber. The method also includes calculating, by the computing device based on the plurality of OTDR traces, a mean OTDR trace. Additionally, the method includes determining, by the computing device using a machine-learned model, a set of correction factors. The correction factors represent point-wise modifications that, when applied to the mean OTDR trace, produce a denoised mean OTDR trace. The correction factors are determined based on the plurality of OTDR traces.

In a second aspect, the disclosure describes an OTDR device. The OTDR device includes a laser configured to emit a series of light pulses into an optical fiber. The OTDR device also includes a light detector configured to acquire a plurality of OTDR traces. The OTDR traces represent backscatter from respective light pulses of the series of emitted light pulses propagated through the optical fiber. Additionally, the OTDR device includes a computing device. The computing device is configured to receive the plurality of OTDR traces from the light detector. The computing device is also configured to calculate, based on the plurality of OTDR traces, a mean OTDR trace. Further, the computing device is configured to determine, using a machine-learned model, a set of correction factors. The correction factors represent point-wise modifications that, when applied to the mean OTDR trace, produce a denoised mean OTDR trace. The correction factors are determined based on the plurality of OTDR traces.

In a third aspect, the disclosure describes a non-transitory, computer-readable medium having instructions stored therein. The instructions, when executed by a processor, perform a method. The method includes receiving a plurality of OTDR traces. The OTDR traces represent backscatter from a respective light pulse propagated through an optical fiber. The method also includes calculating, based on the plurality of OTDR traces, a mean OTDR trace. Additionally, the method includes determining, using a machine-learned model, a set of correction factors. The correction factors represent point-wise modifications that, when applied to the mean OTDR trace, produce a denoised mean OTDR trace. The correction factors are determined based on the plurality of OTDR traces.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is a block diagram illustration of a computing device, according to example embodiments.

FIG. 2 is a block diagram illustration of a cloud-based server cluster, according to example embodiments.

FIG. 3A is a diagram illustrating a system capable of performing an OTDR measurement, according to example embodiments.

FIG. 3B is a block diagram illustrating an OTDR device, according to example embodiments.

FIG. 3C is a block diagram illustrating an OTDR acquisition device of the OTDR device of FIG. 3B, according to example embodiments.

FIG. 4A is an illustration of a method for training a machine-learned model, according to example embodiments.

FIG. 4B is an illustration of a method of making a prediction using a machine-learned model, according to example embodiments.

FIG. 5A is an illustration of a technique for denoising a plurality of OTDR traces.

FIG. 5B is a plot of the results from denoising a plurality of OTDR traces using the technique of FIG. 5A.

FIG. 5C is a plot of the results from denoising a plurality of OTDR traces using the technique of FIG. 5A.

FIG. 6A is an illustration of a technique for denoising a plurality of OTDR traces, according to example embodiments.

FIG. 6B is a plot of the results from denoising a plurality of OTDR traces using the technique of FIG. 6A, according to example embodiments.

FIG. 6C is a plot of the results from denoising a plurality of OTDR traces using the technique of FIG. 6A, according to example embodiments.

FIG. 7A is a block diagram illustrating a machine-learned model, according to example embodiments.

FIG. 7B is a block diagram illustrating a portion of a machine-learned model, according to example embodiments.

FIG. 7C is a block diagram illustrating a portion of a machine-learned model, according to example embodiments.

FIG. 7D is a block diagram illustrating a portion of a machine-learned model, according to example embodiments.

FIG. 8 is a flowchart diagram illustrating a method, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

### 1. Overview

Example embodiments relate to OTDR, and more particularly, to denoising OTDR measurements using machine-learning methods.

During an OTDR measurement, laser pulses may be sent through an optical fiber and the backscattered photons may be measured, in order to provide information on the condition of the optical fiber along the optical path. Because of the inherent attenuation of optical components, such as optical fibers, the forward and reflected signals may get weaker the farther they travel. Thus, in OTDR measurements, the optical power of the signals may span several orders of magnitude (e.g., measurable in units of dB). An OTDR measurement may have several configurable parameters (e.g., pulse width, averaging time, wavelength, avalanche photodiode (APD) gain, etc.). For example, a larger pulse width may be used to acquire an OTDR measurement for longer optical fibers. In some embodiments, a longer pulse width may decrease the corresponding electrical noise, but may also decrease the corresponding spatial resolution with which events within the optical fiber under test may be detected. The dynamic range may represent the ratio between the highest measurable signal and the lowest measurable signal. Further, the dynamic range may be a function of optical saturation (at the upper edge of the dynamic range) and a noise floor (at the bottom edge of the dynamic range).

In some cases, OTDR measurements may aim to characterize an optical fiber by identifying events such as a junction between fiber sections (spliced or connected), macro bends, fiber breaks, etc. Because the speed of light (e.g., the speed of light within the optical fiber under test) is known, the location of events along the optical fiber can be spatially determined using OTDR measurements. In order to detect events, a sufficiently large dynamic range and sufficiently high resolution may be used. Further, in an OTDR measurement, a measurement time may represent the overall time it takes to acquire and denoise the OTDR signal from the optical fiber under test. For example, a final OTDR trace may include an average of many OTDR acquisitions in order to reduce the electronic noise of the OTDR trace (e.g., to provide a more accurate characterization of the optical fiber under test).

In conventional OTDR measurements, while the parameters described above may be configurable, there may be corresponding tradeoffs associated with increasing or decreasing certain parameters. For example, improving the acquisition time (e.g., by reducing the total acquisition time) may traditionally be done at the expense of measurement precision (e.g., reduced event detection accuracy based on increased electronic noise). As such, it would be valuable to be able to lower acquisition time while maintaining the same or only mildly reducing event detection accuracy. Such capabilities may allow for increased productivity in characterizing optical fibers, which is important as demand for optical fiber installation and testing continues to increase.

Historically, faster acquisition has come with drawbacks. For example, reducing acquisition time may increase the noise level, which may prohibit certain reflectometric signatures from being detected. In order to attempt to counteract this, a wider pulse width may be used. However, larger pulse width may result in a reduced spatial resolution along the optical fiber. In some cases, denoising may be performed by mathematically averaging acquisitions. This averaging process necessarily requires at least some additional time, though, as an increased number of acquisitions are used to filter out the noise (e.g., the number of acquisitions, n, is quadratically related to the Signal-to-Noise Ratio (SNR), i.e., a four-fold increase in acquisition time corresponds to a two-fold improvement in SNR). Further, increases in acquisition time directly contribute to increased OTDR test duration.

In order to reduce OTDR test duration (e.g., for applications involving large numbers of optical fibers) without sacrificing SNR or spatial resolution, some techniques involve applying a machine-learned model to denoise (i.e., filter) noisy OTDR acquisitions. Such approaches may be used in lieu of the approach of merely mathematically averaging the OTDR acquisitions.

Neural Processor Units (NPUs) may be used to provide hardware acceleration for machine-learned models. However, an NPU's computation may be performed with reduced resolution compared to a Central Processing Unit (CPU). For example, some NPUs may be limited to uint8 format (which only has 256 states), whereas machine-learned models may be trained in float32 to maximize denoising performance. When converting the machine-learned model from float32 to uint8, the spatial resolution and/or dynamic range used to represent an OTDR trace may be significantly reduced. Moreover, representing an OTDR trace in uint8 may be challenging because the dynamic range of an OTDR trace may be relatively large (e.g., an OTDR trace corresponding to a 5 ns pulse width may roughly range from −450 to 750,000). Such a dynamic range may make it difficult to represent the OTDR trace in uint8 (and, consequently, difficult to execute using an NPU).

To accommodate higher dynamic ranges, while maintaining acceptable spatial resolution and SNR, example embodiments described herein include a different type of machine-learned model. Namely, rather than a machine-learned model that is simply applied to OTDR acquisitions directly to provide a denoised trace, machine-learned models described herein determine a correction factor for the mean trace. Example machine-learned models may be trained to apply a correction factor for each point of the mean trace rather than to output a value for each point of an OTDR trace to denoise the trace.

In various embodiments, this may reduce overall OTDR time, improve SNR for a given OTDR time, and/or allow for the use of NPUs in addition to or instead of CPUs when performing OTDR. Said a different way, embodiments described herein may address the issue of how to leverage NPU acceleration while maintaining high spatial resolution and fidelity of the OTDR traces by using machine-learned models for denoising in order to reduce the overall OTDR acquisition time. Additionally or alternatively, techniques described herein may allow for reduced computation cycles and/or computing power required to provide a denoised OTDR trace that has an acceptable SNR and dynamic range (e.g., when performed on a CPU).

### II. Example Systems

The following description and accompanying drawings will elucidate features of various example embodiments. The embodiments provided are by way of example, and are not intended to be limiting. As such, the dimensions of the drawings are not necessarily to scale.

The manufacturing processes used for optical fibers can produce small fluctuations in the optical fiber structure along one or more segments of the optical fiber. When such fluctuations interact with OTDR test pulses, they may create interferences and modulations that produce a backscattering pattern in the acquired OTDR trace.

OTDR may be used to characterize optical fibers. Further, OTDR may include a diagnostic technique where light pulses are launched into an optical fiber link and the returning light (e.g., arising from backscattering and reflections along the fiber link) is acquired and analyzed (e.g., by an OTDR acquisition device). Various “events” along the optical fiber may be detected and characterized through a proper analysis of the returning light in the time domain. As a result, the insertion loss of the optical fiber under test, as well as each component along the optical fiber, may be characterized and/or localized using OTDR.

The acquired power level of the return signal as a function of time may be referred to as the “OTDR trace” (i.e., the “reflectometric trace”). Further, the point in time along the OTDR trace may be representative of the distance between the OTDR acquisition device and a point along the optical fiber.

As it is understood by a person of skill in the art, in the following description, general OTDR measurement techniques and OTDR trace processing techniques will not be explained in detail herein. For example, signal processing methods for identifying and characterizing events from an OTDR trace will be understood by a person of skill in the art. Similarly, optical hardware and electronics present in an OTDR acquisition device for performing OTDR acquisitions on an optical fiber will not be described in an overly detailed fashion.

Each “OTDR acquisition” is understood to refer to the actions of propagating a test signal that includes one or more test light pulses having the same pulse width in the optical fiber and detecting corresponding return light signal from the optical fiber as a function of time. A test light-pulse signal travelling along the optical fiber will return towards its point of origin either through (distributed) backscattering or (localized) reflections. The acquired power level of the return light signal as a function of time is referred to as the “OTDR trace,” where the return time is representative of the distance between the OTDR acquisition device and a point along the optical fiber. Light acquisitions may be repeated with varied pulse width values to produce a separate OTDR trace for each test pulse width.

In the context of OTDR techniques, each light acquisition may involve propagating a large number of substantially identical light pulses in an optical fiber and averaging the results. In this case, the result obtained from averaging will herein be referred to as a “mean OTDR trace” or an “average OTDR trace”. Multiple factors may be controlled during OTDR acquisitions or from one OTDR acquisition to the next (e.g., gain settings, pulse power, etc.).

As used herein, “backscattering” refers to Rayleigh scattering occurring from the interaction of the travelling light with the optical fiber media all along the optical fiber, resulting in a generally sloped reflected signal (e.g., measured in logarithmic units such as dB) for the OTDR trace, whose intensity disappears at the end of the range of the travelling pulse. “Events” along the optical fiber may result in a localized drop of the backscattered light on the OTDR trace (e.g., which is attributable to a localized loss) and/or in a localized reflection peak on the OTDR trace.

An “event” characterized by the OTDR techniques described herein may be generated by any perturbation along the optical fiber that affects the returning light. For example, an event may be generated by an optical fiber splice along the optical fiber, which may be characterized by a localized loss with little or no reflection. Additionally or alternatively, mating connectors may generate events that typically cause enhanced reflections (although such connectors may be difficult to detect in some instances). OTDR techniques may also be used to identify events such as an optical fiber breakage (e.g., characterized by substantial localized loss and, frequently, a concomitant reflection peak) and/or a bend in the optical fiber (e.g., characterized by loss). Still further, any other component along the optical fiber may also give rise to an “event” that generates localized loss.

OTDR technology may be implemented in a number of different manners. Additionally, advanced OTDR technologies may involve multi-pulse acquisitions and analysis whereby the OTDR acquisition device makes use of multiple acquisitions performed with different pulse widths in order to provide: (i) different spatial resolutions and noise level conditions for event detection and measurement along the optical fiber under test and (ii) a complete mapping of the optical fiber. As such, an OTDR measurement may include multiple OTDR acquisitions performed with different pulse widths or other varying conditions. One or more OTDR traces acquired for a given OTDR measurement may be: (i) saved as part of an OTDR measurement data file or files and (ii) made available to a duplicate OTDR measurement detection application, which may use one or more of the available OTDR traces to compare the OTDR measurements.

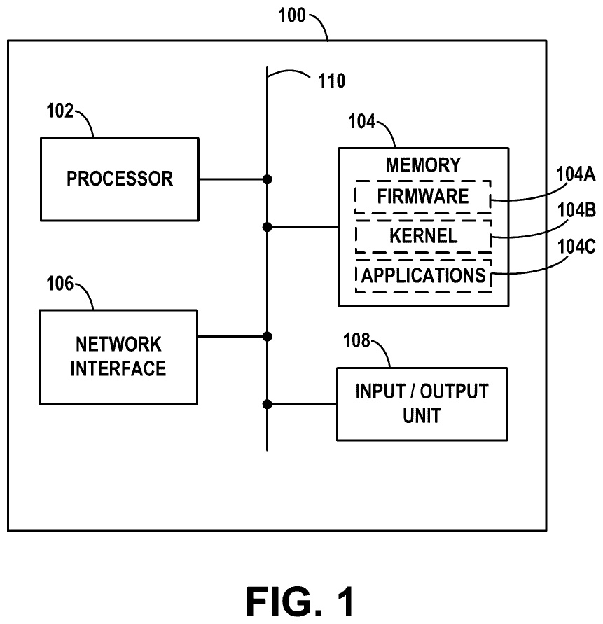

FIG. 1 is a block diagram of a computing device 100, according to example embodiments. FIG. 1 illustrates some of the components that may be included in a computing device arranged to operate in accordance with the embodiments herein. For example, the computing device 100 may represent portions of an OTDR device and/or an OTDR acquisition device. Computing device 100 may be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a CPU, a co-processor (e.g., a mathematics, graphics, or encryption co-processor, an NPU, or a tensor processing unit (TPU)), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. In some embodiments, for example, firmware 104A may include a basic input/output system (BIOS). Kernel 104B may be an operating system, including modules for memory management, scheduling and management of processes, input / output, and communication. Kernel 104B may also include device drivers that allow the operating system to communicate with the hardware modules (e.g., memory units, networking interfaces, ports, and buses) of computing device 100. Applications 104C may be one or more user-space software programs (e.g., mobile applications), such as web browsers, games, or email clients, as well as any software libraries used by these programs. For example, in some embodiments, applications 104C may include one or more machine-learned models used to carry out the OTDR analyses described herein. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (WIFI), BLUETOOTH, global positioning system (GPS), third-generation (3G), fourth-generation (4G), long-term evolution (LTE), fifth-generation (5G), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH, and WIFI interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a USB or high-definition multimedia interface (HDMI) port interface, for example.

In some embodiments, one or more computing devices like computing device 100 may be deployed to support the embodiments herein. The exact physical location, connectivity, and configuration of these computing devices may be unknown and/or unimportant to client devices. Accordingly, the computing devices may be referred to as “cloud-based” devices that may be housed at various remote data center locations.

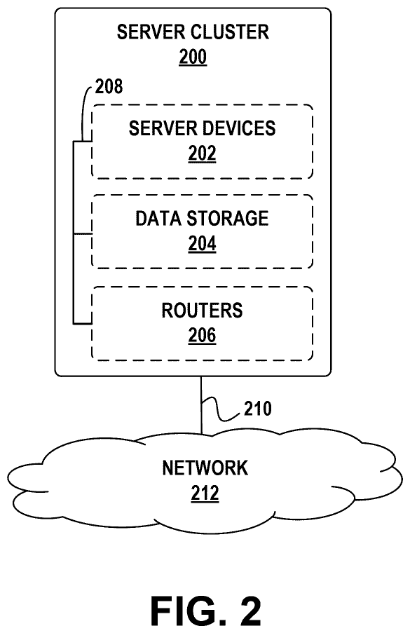

FIG. 2 depicts a server cluster 200 (e.g., a cloud-based server cluster) in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature is understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Routers 206 may include networking equipment configured to provide internal and external communications for server cluster 200. For example, routers 206 may include one or more packet-switching and/or routing devices (including switches and/or gateways) configured to provide: (i) network communications between server devices 202 and data storage 204 via local cluster network 208 and/or (ii) network communications between server cluster 200 and other devices via communication link 210 to network 212.

Additionally, the configuration of routers 206 can be based at least in part on the data communication requirements of server devices 202 and data storage 204; the latency and throughput of the local cluster network 208; the latency, throughput, and cost of communication link 210; and/or other factors that may contribute to the cost, speed, fault-tolerance, resiliency, efficiency, and/or other design goals of the system architecture.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations (e.g., accessible via a web browser). Such a representation may take the form of a markup language, such as HyperText Markup Language (HTML), eXtensible Markup Language (XML), or some other standardized or proprietary format. Moreover, server devices 202 may have the capability of executing various types of computerized scripting languages, such as, but not limited to, Perl, Python, PHP Hypertext Preprocessor (PHP), Active Server Pages (ASP), JAVASCRIPT, and so on. Computer program code written in these languages may facilitate the providing of web pages to client devices, as well as client device interaction with the web pages. Alternatively or additionally, JAVA may be used to facilitate generation of web pages and/or to provide web application functionality.

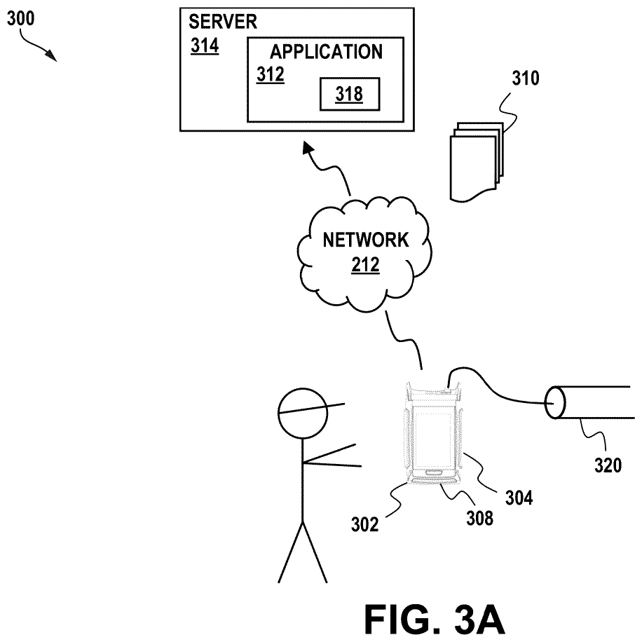

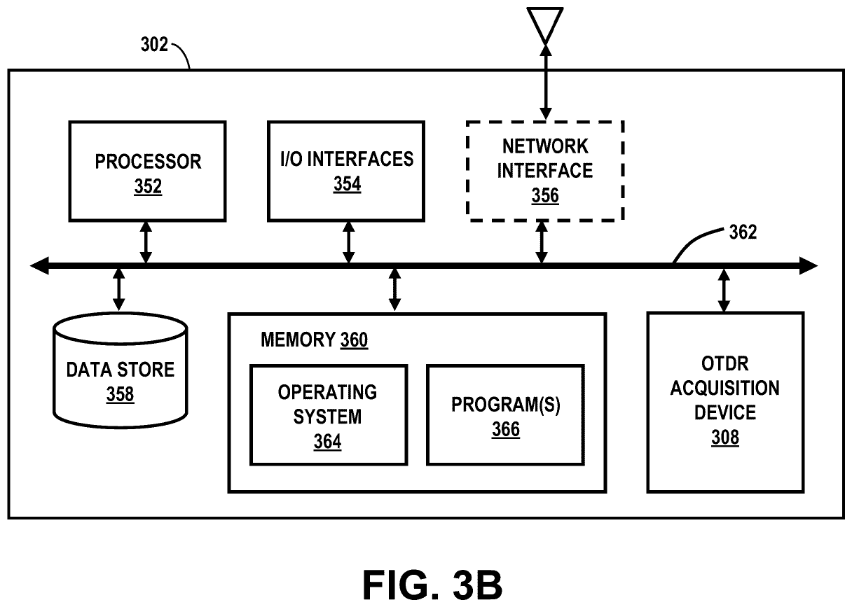

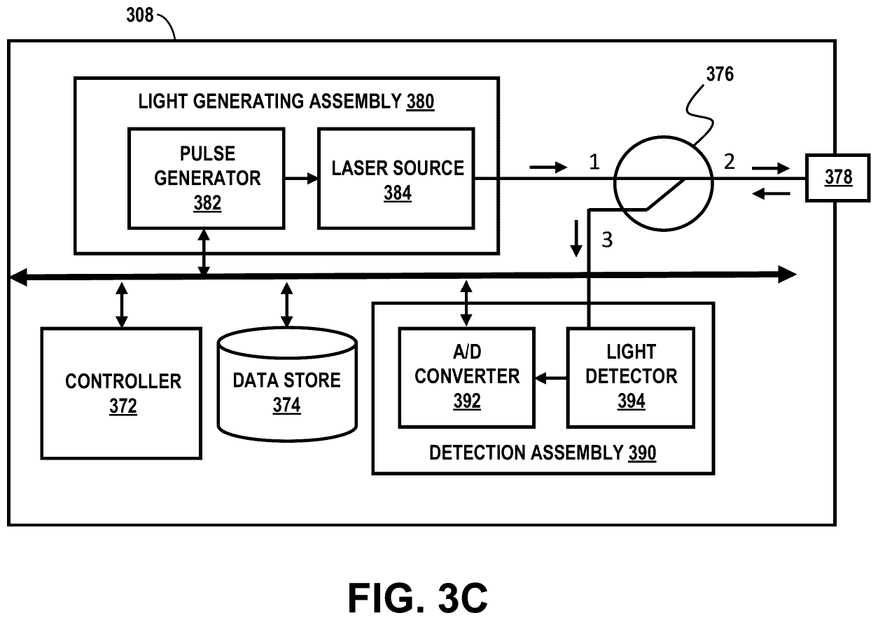

FIG. 3 illustrates a system 300 configured to generate, communicate, and store OTDR measurement results (e.g., initiated by a network operator or technician). As illustrated, the system 300 may include an OTDR device 302 that includes an OTDR acquisition device 308 configured to perform OTDR measurements on an optical fiber 320 (e.g., an optical fiber that is at least 1 km, at least 5 km, at least 10 km, at least 15 km, at least 20 km, at least 25 km, at least 50 km, or at least 100 km in length). When testing the optical fiber 320, the OTDR device 302 may generate one or more OTDR measurement data files 310 (e.g., each of which may include one or more OTDR traces that were acquired to characterize the optical fiber 320). In some embodiments, the OTDR measurement data files 310 may include parameters of the optical fiber 320 (e.g., as determined based on the acquired OTDR trace(s) by an OTDR analysis module 304 that is part of the OTDR device 302).

The OTDR measurement data files 310 may be transferred to a server-based test application 312 that receives the OTDR measurement data files 310 and may optionally track the progress and completion of the OTDR measurement and/or accept and/or verify OTDR measurement data files 310. The test application 312 may be located in a server 314 (e.g., similar to the server devices 202 in the server cluster 200 shown and described with reference to FIG. 2). The server 314 and the OTDR device 302 may communicate over a network (e.g., such as the network 212 shown and described with reference to FIG. 2). In some embodiments, a test report may be prepared by the technician (e.g., using the OTDR device 302) and transferred to the test application 312 (e.g., via the network 212) in addition to or instead of the OTDR measurement data files 310. In some embodiments, a test report may be prepared by the test application 312.

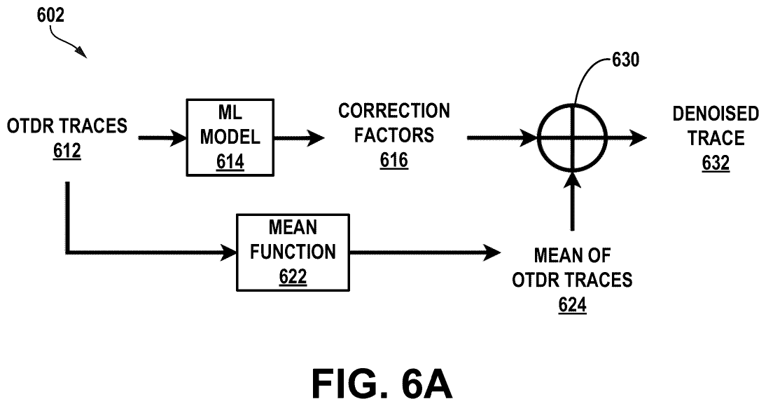

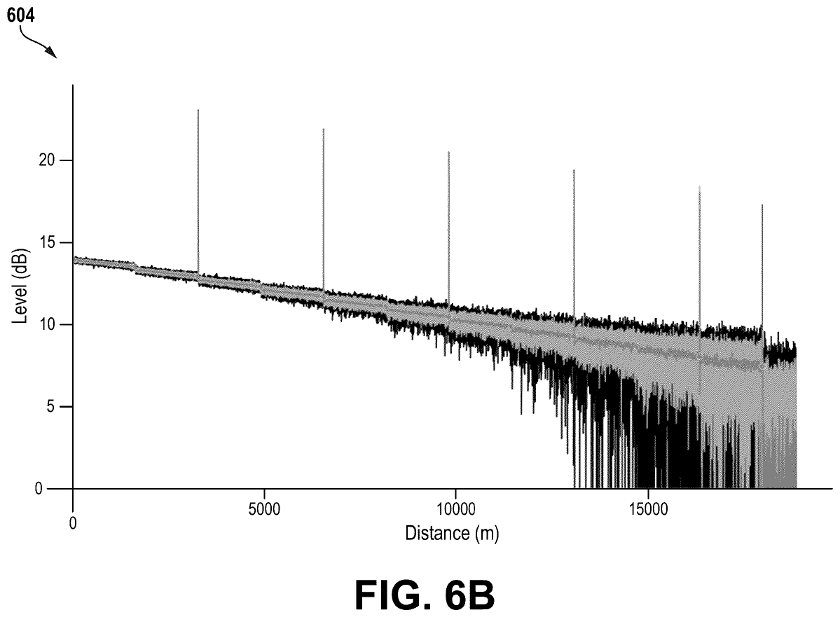

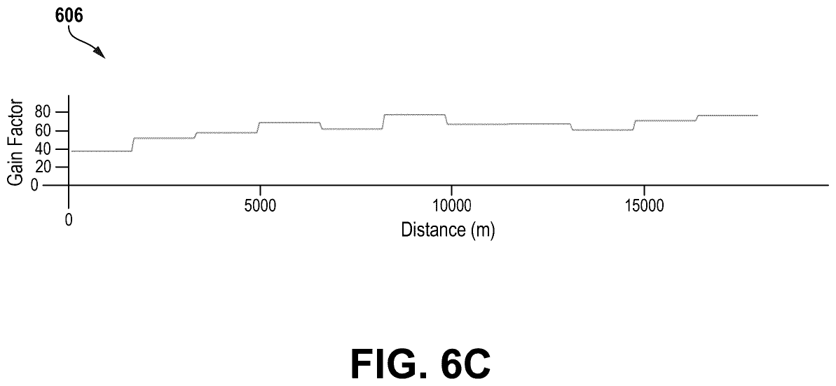

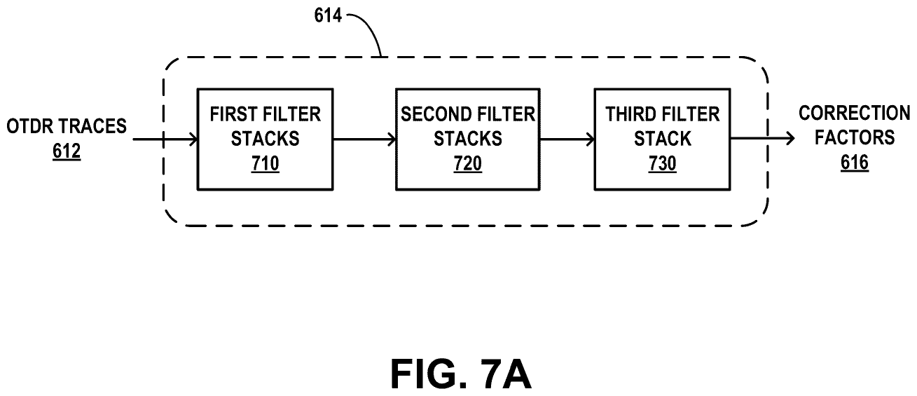

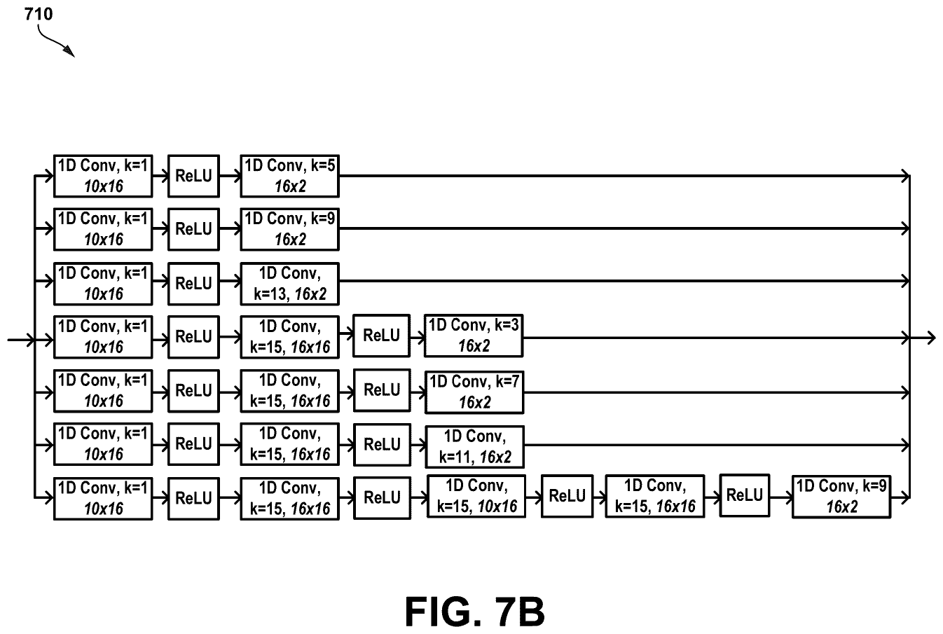

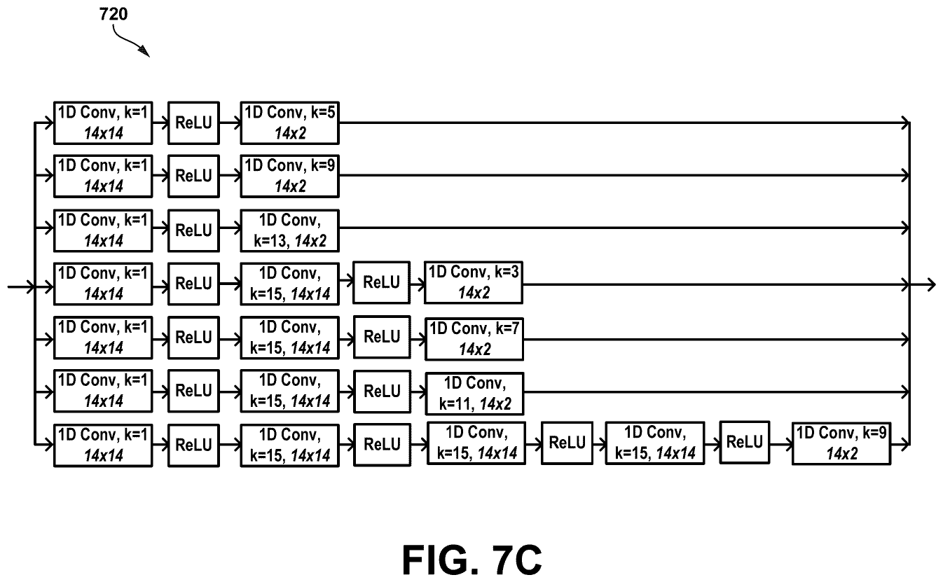

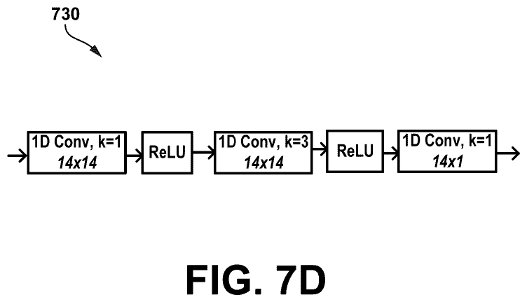

In the system 300 illustrated in FIG. 3A, the test application 312 and/or the OTDR device 302 may include a denoising module 318. The denoising module 318 may be configured to accept the OTDR measurement data files 310 and, based on the data files, generate a denoised OTDR trace (e.g., from which one or more defects within the optical fiber 320 may be identified). The denoised OTDR trace may be generated using one or more machine-learned models (e.g., the machine-learned model 614 shown and described with reference to FIGS. 6A and 7A-7D). The machine-learned model(s) may be configured to determine a series of correction factors relative to a mean OTDR trace (e.g., where the mean OTDR trace is determined based on the OTDR measurement data files 310) in order to denoise the mean OTDR trace.

FIG. 3B is a block diagram of an OTDR device (e.g., the OTDR device 302 shown and described with reference to FIG. 3A). The OTDR device 302 may be a digital device that includes a processor 352 (e.g., similar to the processor 102 shown and described with reference to FIG. 1), input/output (I/O) interfaces 354 (e.g., similar to the input/output unit 108 shown and described with reference to FIG. 1), a network interface 356 (e.g., similar to the network interface 106 shown and described with reference to FIG. 1), a data store 358, a memory 360, and an OTDR acquisition device (e.g., similar to the OTDR acquisition device 308 shown and described with reference to FIG. 3A). In other embodiments, additional and/or alternative components may be included in the OTDR device 302.

A local interface 362 may interconnect one or more of the components of FIG. 3B. The local interface 362 may include, for example, one or more buses or other wired or wireless connections. In some embodiments, the local interface 362 may include controllers, buffers (caches), drivers, repeaters, and/or receivers to enable communication between components. Further, the local interface 362 may include address, control, and/or data connections that enable appropriate data routing among the components of the OTDR device 302.

When the OTDR device 302 is in operation, the processor 352 may be configured to execute instructions stored within the memory 360, to communicate data to and from the memory 360 and/or to control operations of the OTDR device 302. In some embodiments, the processor 352 may include a mobile processor optimized for power consumption and/or mobile applications. The I/O interfaces 354 may be used to receive user input from and/or for providing system output. User input can be provided via, for example, a keypad, a mouse, a touch screen, a scroll ball, a scroll bar, buttons, a barcode scanner, etc. Further, outputs from the OTDR device 302 may be displayed on one or more display devices of the I/O interfaces 354 (e.g., a liquid crystal display (LCD), touch screen, etc.). The I/O interfaces 354 may include a graphical user interface (GUI) that enables a user to interact with the OTDR device 302.

The network interface 356 may enable wireless communication to an external access device or network. Any number of suitable wireless data communication protocols, techniques, or methodologies may be supported by the network interface 356.

The data store 358 may be used to store data, such as OTDR traces and/or OTDR measurement data files. In some embodiments, the data store 358 may include any of volatile memory elements (e.g., RAM), nonvolatile memory elements (e.g., ROM), and/or combinations thereof. Moreover, the data store 358 may incorporate electronic, magnetic, optical, and/or other types of storage media.

The memory 360 may include any of volatile memory elements (e.g., RAM), nonvolatile memory elements (e.g., ROM), and/or combinations thereof. Moreover, the memory 360 may incorporate electronic, magnetic, optical, and/or other types of storage media. In some embodiments, the memory 360 may have a distributed architecture, where various components are situated remotely from one another, but can be accessed by the processor 352. The computer-readable instructions stored within memory 360 can include one or more computer programs 366, each of which may include one or more ordered listings of executable instructions for implementing logical functions. As illustrated, memory 360 may include an operating system (O/S) 364 in addition to computer programs 366. The operating system 364 may control the execution of other computer programs 366 and/or provide scheduling, input-output control, file and data management, memory management, and communication control and related services. The programs 366 may include various applications, add-ons, etc. configured to provide end-user functionality with the OTDR device 302. For example, example programs 366 may include a web browser to connect with a server for transferring OTDR measurement data files and/or a dedicated OTDR application configured to control OTDR acquisitions by the OTDR acquisition device 308, set OTDR acquisition parameters, analyze OTDR traces obtained by the OTDR acquisition device 308, and display a GUI related to the OTDR device 302. For example, the dedicated OTDR application may include an OTDR analysis module configured to analyze acquired OTDR traces in order to characterize the optical fiber under test, and produce OTDR measurement data files. The dedicated OTDR application may also include a module that includes the denoising module configured to denoise a mean OTDR trace using a machine-learned model that generates one or more correction factors as described herein.

It is noted that, in some embodiments, the I/O interfaces 354 may be provided by a physically distinct mobile device (not illustrated), such as a handheld computer, a smartphone, a tablet computer, a laptop computer, a wearable computer etc. For example, a mobile device may be communicatively coupled to the OTDR device 302 via the network interface 356. In such cases, at least some of the programs 366 may be located in a memory of such a mobile device, for execution by a processor of the mobile device. Further, in some embodiments, the mobile device may also include a network interface used to transfer OTDR measurement data files 310 to a server 114.

The OTDR device 302 shown and described with reference to FIGS. 3A and 3B is provided solely as an example. Additional and alternative components for the OTDR device 302 are also possible and are contemplated herein.

FIG. 3C is a block diagram illustrating an OTDR acquisition device (e.g., the OTDR acquisition device 308 shown and described with reference to FIGS. 3A and 3B). As illustrated in FIG. 3A, the OTDR acquisition device 308 may be connectable to an optical fiber 320 in order to perform one or more OTDR measurements. For example, the OTDR acquisition device 308 may be connected via an output interface 378 to the optical fiber 320 in order to perform OTDR acquisitions. The OTDR acquisition device 308 may include optical hardware and electronics in order to perform OTDR measurements of the optical fiber 320. For example, the OTDR acquisition device 308 may include a light generating assembly 380, a detection assembly 390, a directional coupler 376, a controller 372, and a data store 374.

The light generating assembly 380 may include a laser source 384 that is driven by a pulse generator 382 to generate an OTDR test signal that includes test light pulses having one or more predefined characteristics. The light generating assembly 380 may be configured to generate test light pulses of varied pulse widths, repetition periods, and/or optical powers through control of the pattern produced by the pulse generator 382. In some cases, different OTDR measurements may be performed at different wavelengths. For this reason, in some embodiments, the light generating assembly 380 may be configured to generate test light pulses that have different wavelengths by including a tunable laser source 384. In some embodiments, the light generating assembly 380 may include both pulse width and wavelength control capabilities. In some embodiments, the light generating assembly 380 may include additional or alternative components, such as modulators, lenses, mirrors, optical filters, wavelength selectors, etc.

The light generating assembly 380 may be coupled to the output interface 378 of the OTDR acquisition device 308 through a directional coupler 376 (e.g., a circulator) that has three or more ports. The first port may be connected to the light generating assembly 380 to receive the test light pulses therefrom. The second port may be connected to the output interface 378. The third port may be connected to the detection assembly 390. The connections may be arranged such that test light pulses generated by the light generating assembly 380 are coupled to the output interface 378 and the return light signal arising from backscattering and reflections along the optical fiber 320 is coupled to the detection assembly 390.

As illustrated in FIG. 3C, the detection assembly 390 may include a light detector 394 (e.g., a photodiode, an avalanche photodiode, or any other suitable photodetector) that detects the return light signal corresponding to each test light pulse and an analog-to-digital converter 392 to convert the electrical signal proportional to the detected return light signal from analog to digital in order to allow data storage and processing. In some embodiments, the detected return light signal may be amplified, filtered, or otherwise processed before analog to digital conversion. The power level of returning light signals as a function of time (e.g., which is obtained from the detection and conversion described above) may be referred to as one acquisition of an OTDR trace. In the context of OTDR, each light acquisition may involve propagating a large number of substantially identical light pulses in the optical fiber 320 and averaging the results in order to improve the SNR. In such cases, the result obtained from averaging may be referred to herein as an OTDR trace. In some embodiments, the OTDR acquisition device 308 may also be used to perform multiple acquisitions with varied pulse widths to obtain a multi-pulsewidth OTDR measurement.

The OTDR acquisition device 308, and more specifically the light generating assembly 380 may be controlled by the controller 372. The controller 372 may include a hardware logic device. As such, the controller 372 may include one or more field programmable gate array (FPGAs), one or more application specific integrated circuits (ASICs), or one or more processors configured with a state machine or stored program instructions. When the OTDR acquisition device 308 is in operation, the controller 372 may be configured to control the OTDR measurement process. The controller 372 may control parameters of the light generating assembly 380 according to OTDR acquisition parameters that are either provided by the operator of the OTDR software or otherwise determined by program(s) 366.

The data store 374 may be used to accumulate raw data received from the detection assembly 390, as well as intermediary averaged results and resulting OTDR traces. The data store 374 may include any volatile memory elements (e.g., RAM). Further, the data store 374 may be embedded with or separate from the controller 372. The OTDR traces acquired by the OTDR acquisition device 308 may be received and analyzed by one or more of the computer programs 366 and/or stored in data store 358 for future processing.

The architecture of the OTDR acquisition device 308 is provided solely as an example. Numerous types of optical and electronic components are available and can be used to implement the OTDR acquisition device 308 in alternative embodiments.

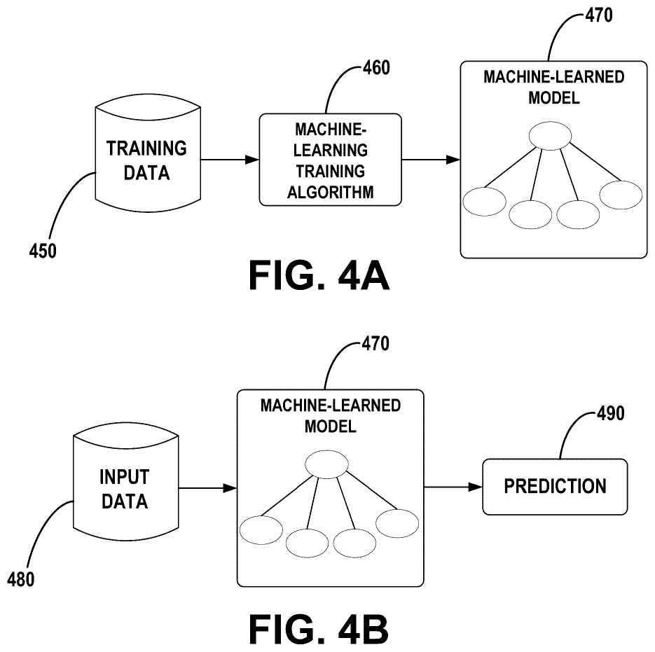

FIG. 4A illustrates a method of training a machine-learned model 470 (e.g., an artificial neural network (ANN), such as a deep ANN; a generative adversarial network (GAN); or a support vector machine), according to example embodiments. The method of FIG. 4A may be performed by a computing device (e.g., the computing device 100 illustrated in FIG. 1), in some embodiments. As illustrated, the machine-learned model 470 may be trained using a machine-learning training algorithm 460 based on training data 450 (e.g., based on patterns within the training data 450). While only one machine-learned model 470 is illustrated in FIGS. 4A and 4B, it is understood that multiple machine-learned models could be trained simultaneously and/or sequentially and used to perform the predictions described herein. For example, in the case of a GAN, one or more generators and one or more discriminators could be simultaneously trained. Ultimately, a prediction 490 may be made using the trained machine-learned model 470. For example, the machine-learned model 470 may be used (e.g., by the computing device 100) to determine a correction factor for a mean OTDR trace in order to denoise the mean OTDR trace.

The machine-learned model 470 may include, but is not limited to: one or more ANNs (e.g., one or more convolutional neural networks, one or more recurrent neural networks, one or more Bayesian networks, one or more hidden Markov models, one or more Markov decision processes, one or more logistic regression functions, one or more suitable statistical machine-learning algorithms, one or more heuristic machine-learning systems, one or more GANs, etc.), one or more support vector machines, one or more regression trees, one or more ensembles of regression trees (i.e., regression forests), one or more decision trees, one or more ensembles of decision trees (i.e., decision forests), and/or some other machine-learning model architecture or combination of architectures.

The machine-learning training algorithm 460 may involve supervised learning, semi-supervised learning, reinforcement learning, and/or unsupervised learning. Similarly, the training data 450 may include labeled training data and/or unlabeled training data. Further, similar to described above with respect to the machine-learned model 470, a number of different machine-learning training algorithms 460 could be employed herein. If the machine-learned model 470 includes a GAN, the machine-learning training algorithm 460 may include training one or more discriminator ANNs and one or more generator ANNs based on the training data 450.

Additionally, the machine-learning training algorithm 460 may be tailored and/or altered based on the machine-learned model 470 to be generated (e.g., based on desired characteristics of the output machine-learned model 470). Further, the training data 450 may be used to train the machine-learned model 470 using the machine-learning training algorithm 460. For example, the machine-learned model 470 may include labeled training data that is used to train the machine-learned model 470. For instance, training discriminator(s)/generator(s) may occur in a supervised fashion using labeled training data and/or using sample input training data for the generator(s). Further, in some embodiments, the machine-learning training algorithm 460 may enforce rules during the training of the machine-learned model 470 through the use of one or more hyperparameters.

Once the machine-learned model 470 is trained by the machine-learning training algorithm 460 (e.g., using the method of FIG. 4A), the machine-learned model 470 may be used to make one or more predictions (i.e., inferences). For example, a computing device (e.g., the computing device 100 shown and described with reference to FIG. 1), may make a prediction 490 using the machine-learned model 470 based on input data 480, as illustrated in FIG. 4B.

The training data 450 used to train a machine-learned model 470 as described herein (e.g., the machine-learned model 614 shown and described below with reference to FIGS. 6A and 7A-7D) may include a series of previously captured OTDR traces as an input and a single, ground-truth OTDR trace (e.g., a fully denoised mean OTDR trace) as a desired output. Many pairs of OTDR traces/single, ground-truth OTDR trace may be used to robustly train the machine-learned models 470 described herein. Additionally or alternatively, in some embodiments, machine-learned models 470 described herein may be continuously updated as they are used. For example, upon additional OTDR traces being captured and processed by an OTDR device (e.g., the OTDR device 302 shown and described with reference to FIGS. 3A and 3B), the machine-learned model 470 may be re-trained using the additional OTDR traces as new training data 450 (e.g., in additional to the previously used training data 450). Such additional training may be performed by the OTDR device 302 or by a separate computing device (e.g., a server device, a cloud device, a mobile device, a tablet device, etc.).

While the same computing device (e.g., a computing device 100 as in FIG. 1) may be used to both train the machine-learned model 470 (e.g., as illustrated in FIG. 4A) and make use of the machine-learned model 470 to make a prediction 490 (e.g., as illustrated in FIG. 4B), it is understood that this need not be the case. In some embodiments, for example, a computing device may execute the machine-learning training algorithm 460 to train the machine-learned model 470 and may then transmit the machine-learned model 470 to another computing device for use in making one or more predictions 490. In the context of this disclosure, for example, a computing device may be used to initially train the machine-learned model 470 and then this machine-learned model 470 could be stored for later use.

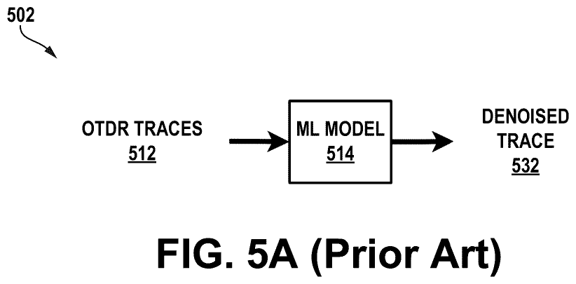

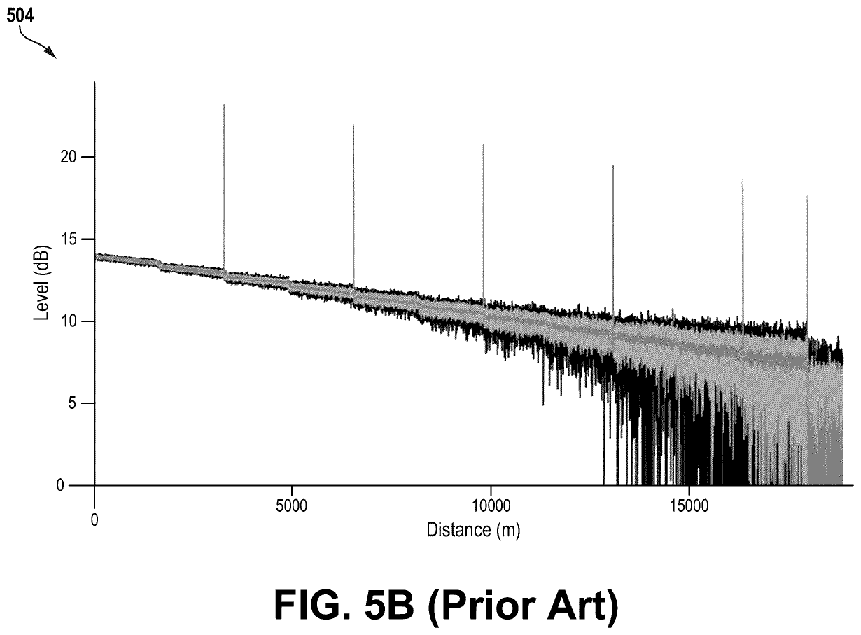

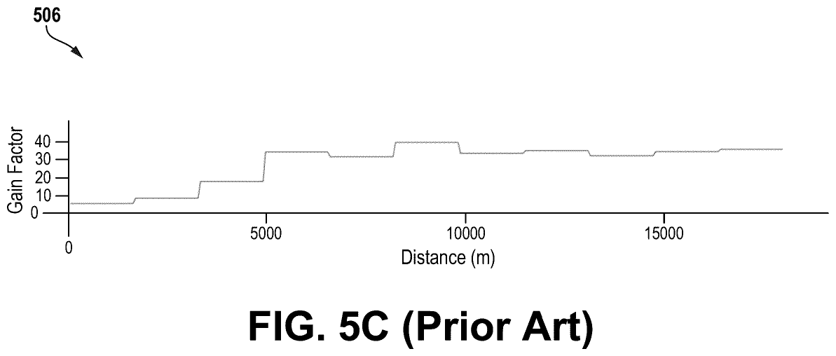

FIG. 5A is an illustration of a technique 502 for denoising a plurality of OTDR traces. As illustrated, the denoising technique 502 may process a plurality of OTDR traces 512 (e.g., 10 OTDR traces 512 containing noise) using a machine-learned model 514 in order to generate a denoised trace 532. In some cases, each OTDR trace of the plurality of OTDR traces 512 may include at least 10,000 discrete points (e.g., each corresponding to a discrete acquisition by a photodetector, such as the light detector 394 shown and described with reference to FIG. 3C), the denoised trace may include at least 10,000 discrete points (or more or fewer, such as at least 1,000 discrete points, at least 5,000 discrete points, at least 15,000 discrete points, etc.), and/or the pulse widths of the respective light pulses propagated through the optical fiber under test (e.g., based on illuminations from a light source, such as the laser source 384 shown and described with reference to FIG. 3C) to generate the plurality of OTDR traces may each be at most 5 ns. Other values are also possible (e.g., at most 1 ns, at most 2 ns, at most 3 ns, at most 4 ns, at most 6 ns, etc.). Additionally, or alternatively, the plurality of OTDR traces 512 may be captured over a predefined acquisition time per trace (e.g., 2 seconds, 1 second, 0.5 seconds, 0.1 second, etc.).

Processing the OTDR traces 512 may include applying the machine-learned model 514 directly to the OTDR traces 512. Example embodiments described herein (e.g., shown and described with reference to FIGS. 6A-7D) provide improvements to OTDR technology when compared to the denoising technique 502 illustrated in FIG. 5A by reducing the amount of acquisition time required to produce a target amount of denoising in a denoised trace, reducing the amount of computation power required to produce a target amount of denoising in a denoised trace, and/or improving the amount of denoising for a given amount of acquisition time and computation power.

FIG. 5B is a plot 504 of the results from denoising a plurality of OTDR traces using the technique 502 of FIG. 5A. The y-axis represents the level (measured in dB) of a given waveform (e.g., corresponding to the intensity of a measured OTDR trace) and the x-axis represents the distance (measured in m) along the optical fiber under test (e.g., deduced based on the time of receipt of given reflections of the illumination signal). As illustrated, the optical fiber under test in the plot 504 of FIG. 5B may be at least 15 km in length. In the plot 504 of FIG. 5B, the black-colored waveform may represent one example average of the OTDR traces 512 (i.e., a mean OTDR trace) used as an input in FIG. 5A. The black-colored waveform may be captured over an acquisition time (e.g., 10 OTDR traces 512 each captured for 1 s each, resulting in a total acquisition time of 10 s). Likewise, the marigold-colored waveform (overlaying the black-colored waveform) in the plot 504 may represent an OTDR trace that includes a target amount of denoising (e.g., set by a standards organization) of the mean OTDR trace (the black-colored waveform) that could be achieved in a predefined amount of time (e.g., 30 seconds). Further, the vermillion-colored waveform (overlaying both the black-colored and marigold-colored waveforms) in the plot 504 may represent a denoised trace 532 generated after a given processing time. In other words, the vermillion-colored waveform in the plot 504 may represent an OTDR trace that corresponds to the mean OTDR trace (the black-colored waveform) once it has been denoised using the denoising technique 502 illustrated in FIG. 5A in a given inference time. In some cases, the predefined amount of time (e.g., including acquisition time per OTDR trace and/or inference time for applying the machine-learned model 514) may correspond to or be set based on the total amount of time that an optical engineer and/or technician is willing to wait for results to be generated using an OTDR device (e.g., the OTDR device 302 shown and described with reference to FIG. 3B).

The green-colored waveform (overlaying all of the black-colored, the marigold-colored, and the vermillion-colored waveforms) in the plot 504 may represent a ground-truth waveform (i.e., a waveform with no coherent noise, such as speckle, and no non-coherent noise, such as electronic noise). For example, the green-colored waveform may be a waveform generated by an OTDR acquisition device (e.g., the OTDR acquisition device 308 shown and described in FIG. 3C) and then attenuated according to underlying optical attenuation, spectral noise, and electronic noise within the optical fiber under test and the associated sensors of the OTDR acquisition device using a simulation (e.g., a computer simulation) based on detected events. Additionally, or alternatively, in some example denoising techniques 502, the green-colored waveform may be used to train a machine-learned model (e.g., the machine-learned model 514 shown and described with reference to FIG. 5A). For example, the green-colored waveform may be used as the desired solution for a loss function (e.g., a loss function used in a machine-learning training algorithm, such as the machine-learning training algorithm 460 shown and described with reference to FIG. 4A). In still other embodiments, the green-colored waveform may be generated by an OTDR acquisition device with an incredibly long acquisition time (e.g., allowing for a significant reduction in all non-coherent noise).

FIG. 5C is a plot 506 of the results from denoising a plurality of OTDR traces using the technique 502 of FIG. 5A. In particular, the plot 506 of FIG. 5C may illustrate a gain factor resulting from the denoising technique 502 of FIG. 5A. In other words, the plot 506 of FIG. 5C may correspond to a ratio between the SNR of the vermillion-colored waveform in FIG. 5B and the SNR of the black-colored waveform in FIG. 5B. As illustrated, the gain factor ranges from about 5 to about 40 at different segments along the optical fiber under test. For example, the optical fiber under test may be separated into different segments that are delineated from one another based on the locations of splices or reflective events along the optical fiber under test. The plot 506 of FIG. 5C may be used as a point of reference to demonstrate the improvements to OTDR technology rendered by embodiments described herein. For example, improvements rendered by embodiments described herein may be evident by comparing the results illustrated in the plot 506 of FIG. 5C to the results illustrated in the plot 606 of FIG. 6C (described below).

FIG. 6A is an illustration of a technique 602 for denoising a plurality of OTDR traces 612 (e.g., 10 OTDR traces), according to example embodiments. The denoising technique 602 illustrated in FIG. 6A may be performed using the system 300 illustrated in FIG. 3A (e.g., including the OTDR device 302), a client device (e.g., a mobile device, personal computer, laptop computer, or tablet device of an optical engineer and/or technician), a server device (e.g., the server devices 202 shown and described with reference to FIG. 2), and/or a computing device (e.g., the computing device 100 shown and described with reference to FIG. 1). Like FIG. 5A (e.g., and in order to draw a meaningful comparison to the denoising technique 502 of FIG. 5A), each OTDR trace of the plurality of OTDR traces 612 may include at least 10,000 discrete points (e.g., each corresponding to a discrete acquisition event by a photodetector, such as light detector 394 shown and described with reference to FIG. 3C), the denoised trace may include at least 10,000 discrete points, and/or the pulse widths of the respective light pulses propagated through the optical fiber under test (e.g., based on illuminations from a light source, such as the laser source 384 shown and described with reference to FIG. 3C) to generate the plurality of OTDR traces may each be at most 5 ns. Additionally or alternatively, the plurality of OTDR traces 612 may be captured over a predefined acquisition time per trace (e.g., 2 seconds, 1 second, 0.5 seconds, 0.1 second, etc.).

As illustrated, the plurality of OTDR traces 612 may be processed along two parallel paths. In a first path, the OTDR traces may be fed into a machine-learned model 614 (e.g., a machine-learned model trained using the technique shown and described with reference to FIG. 4A and/or a machine-learned model similar to the machine-learned model 700 shown and described with reference to FIGS. 7A-7D). The machine-learned model 614 may be used to generate a set of correction factors 616 that is provided to adder 630. The set of correction factors 616 may be usable (e.g., when applied to the mean of OTDR traces 624 using the adder 630) to denoise a mean OTDR trace (e.g., the mean of OTDR traces 624). For example, the set of correction factors 616 may include 10,000 correction factors, each of which may be used to scale a different point along a mean OTDR trace in order to denoise that mean OTDR trace. Other numbers of correction factors are possible (e.g., 100, 500, 1,000, 5,000, 15,000, 20,000, etc.). In a second path, the OTDR traces 612 may be fed into a mean function 622. The mean function 622 may generate a mean of OTDR traces 624, which is provided to the adder 630 thereafter. The adder 630 may combine the set of correction factors 616 with the mean of OTDR traces 624 to generate a single denoised trace 632. In some embodiments, rather than using a mean function 622 to generate a mean OTDR trace, the mean OTDR trace may instead be a secondary output from the machine-learned model 614. In such embodiments, the denoising technique 602 may only include a single processing path (e.g., rather than the parallel paths illustrated in FIG. 6A).

The denoising technique 602 of FIG. 6A is different from the denoising technique 502 shown and described with reference to FIG. 5A in multiple ways. For example, instead of directly generating a denoised trace 532 like the machine-learned model 514 shown and described with reference to FIG. 5A, the machine-learned model 614 may be used to generate a set of correction factors 616 that can be combined at each point of a mean OTDR trace to generate a denoised trace 632. The denoising technique 602 in FIG. 6A, then, may allow for a smaller machine-learned model (e.g., a machine-learned model having fewer parameters and/or reduced inference times compared to the machine-learned model 514 shown and described with reference to FIG. 5A). Further, the machine-learned model 614 may require a reduced dynamic range of possible values to produce adequate outputs when compared to the machine-learned model 514 shown and described with reference to FIG. 5A since the machine-learned model 614 has a baseline (i.e., the mean OTDR trace) upon which to base an inference. Such a reduction in maximum dynamic range may allow the machine-learned model 614 of FIG. 6A to be more precise than the machine-learned model 514 of FIG. 5A (e.g., for a given amount of occupied memory).

In some embodiments, the generated denoised trace 632 may be used to identify a malfunctioning fiber splice associated with the optical fiber under test and/or a malfunctioning connector associated with the optical fiber under test. In such embodiments, the generated denoised trace 632 may also be used to determine a location along the optical fiber under test of the malfunctioning fiber splice and/or of the malfunctioning connector. Based on such determinations, the malfunctioning fiber splice, the malfunctioning connector, and/or the entire optical fiber under test may be repaired or replaced.

In some embodiments, at least two of the OTDR traces 612 may have been captured using different sensor gain settings (e.g., different gain settings for a light detector 394 of an OTDR acquisition device 308 acquiring the OTDR traces 612). For example, a first set of OTDR traces may be captured using a first sensor gain setting and then a second set of OTDR traces may be captured using a second sensor gain setting (e.g., with all other detection settings, such as pulse width, acquisition time, etc., remaining the same). The first set of OTDR traces and the second set of OTDR traces may then be combined to form the OTDR traces 612 illustrated in FIG. 6A. In embodiments where at least two of the OTDR traces 612 are captured using different sensor gain settings, the machine-learned model 614 may be configured to accommodate a plurality of sensor gain settings. For example, the machine-learned model 614 may be trained to use a corresponding plurality of scaling factors to scale OTDR traces captured using different sensor gain settings (e.g., such that the OTDR traces captured using different sensor gain settings may be meaningfully combined into a single mean OTDR trace). While the example of two different sensor gain settings has been described, other numbers of disparate sensor gain settings within the OTDR traces 612 are also possible (e.g., three different sensor gain settings, four different sensor gain settings, five different sensor gain settings, etc.). For example, low gain, medium gain, and high gain settings may be combined in the set of OTDR traces 612. Combining OTDR traces that include different sensor gain settings may sometimes be referred to as “stitching.”

FIG. 6B is a plot 604 of the results from denoising a plurality of OTDR traces using the technique 602 of FIG. 6A. The y-axis represents the level (measured in dB) of a given waveform (e.g., corresponding to the intensity of a measured OTDR trace) and the x-axis represents the distance (measured in m) along the optical fiber under test (e.g., deduced based on the time of receipt of given reflections of the illumination signal). As illustrated, the optical fiber under test in the plot 604 of FIG. 6B may be at least 15 km in length. Other lengths are also possible (e.g., at least 1 km, at least 2 km, at least 3 km, at least 4 km, at least 5 km, at least 10 km, at least 20 km, at least 25 km, etc.). In the plot 604 of FIG. 6B, the black-colored waveform may represent one example average of the OTDR traces 612 (i.e., a mean OTDR trace) used as an input in FIG. 6A. The black-colored waveform may be captured over an acquisition time (e.g., 10 OTDR traces 612 each captured for 1 s each, resulting in a total acquisition time of 10 s). Likewise, the marigold-colored waveform (overlaying the black-colored waveform) in the plot 604 may represent an OTDR trace that includes a target amount of denoising (e.g., set by a standards organization) of the mean OTDR trace (the black-colored waveform) that could be achieved in a predefined amount of time (e.g., 30 seconds). Further, the vermillion-colored waveform (overlaying both the black-colored and the marigold-colored waveforms) in the plot 604 may represent a denoised trace 632 generated after a given processing time. In other words, the vermillion-colored waveform in the plot 604 may represent an OTDR trace that corresponds to the mean OTDR trace (the black-colored waveform) once it has been denoised using the denoising technique 602 illustrated in FIG. 6A in a given inference time. In some cases, the predefined amount of time (e.g., including acquisition time per OTDR trace and/or inference time for applying the machine-learned model 614) may correspond to or be set based on the total amount of time that an optical engineer and/or technician is willing to wait for results to be generated using an OTDR device (e.g., the OTDR device 302 shown and described with reference to FIG. 3B).

The green-colored waveform (overlaying all of the black-colored, the marigold-colored, and the vermillion-colored waveforms) in the plot 604 may represent a ground-truth waveform (i.e., a waveform with no coherent noise, such as speckle, and no non-coherent noise, such as electronic noise). For example, the green-colored waveform may be a waveform generated by an OTDR acquisition device (e.g., the OTDR acquisition device 308 shown and described in FIG. 3C) and then attenuated according to underlying optical attenuation, spectral noise, and electronic noise within the optical fiber under test and the associated sensors of the OTDR acquisition device using a simulation (e.g., a computer simulation) based on detected events. Additionally, or alternatively, in some embodiments described herein, the green-colored waveform may be used to train a machine-learned model (e.g., the machine-learned model 614 shown and described with reference to FIG. 6A). For example, the green-colored waveform may be used as the desired solution for a loss function (e.g., a loss function used in a machine-learning training algorithm, such as the machine-learning training algorithm 460 shown and described with reference to FIG. 4A). In still other embodiments, the green-colored waveform may be generated by an OTDR acquisition device with an incredibly long acquisition time (e.g., allowing for a significant reduction in all non-coherent noise).

FIG. 6C is a plot 606 of the results from denoising a plurality of OTDR traces using the technique 602 of FIG. 6A. In particular, the plot 606 of FIG. 6C may illustrate a gain factor resulting from the denoising technique 602 of FIG. 6A. In other words, the plot 606 of FIG. 6C may correspond to a ratio between the SNR of the vermillion-colored waveform in FIG. 6B and the SNR of the black-colored waveform in FIG. 6B. As illustrated, the gain factor ranges from about 35 to about 75 at different segments along the optical fiber under test. For example, the optical fiber under test may be separated into different segments that are delineated from one another based on the locations of splices or reflective events along the optical fiber under test.

When compared to the plot 506 of FIG. 5C, the plot 606 of FIG. 6C demonstrates the improvements to OTDR technology rendered by embodiments described herein. For example, the plots 506, 606 were both generated on the same example optical fiber under test using the same number of example OTDR traces 512, 612 (e.g., 10 OTDR traces) captured over the same amount of time (e.g., 1 s each) and analyzed over the same inference time using equivalent example computational hardware (e.g., same processing power, same memory, etc.). As illustrated, though, the gain factor of the plot 606 generated using the denoising technique 602 illustrated in FIG. 6A is universally higher throughout all points along the optical fiber under test than the denoising technique 502 illustrated in FIG. 5A (e.g., typically by a factor of 2 or more).

Similarly, though not illustrated, equivalent results to those generated in the plot 506 of FIG. 5C could be generated by the denoising technique 602 illustrated in FIG. 6A but using less computation power and/or a shorter inference time. Hence, the denoising technique 602 in FIG. 6A is more computationally efficient than the denoising technique 502 illustrated in FIG. 5A.

A wide range of architectures of the machine-learned model 614 shown and described with reference to FIG. 6A are possible and contemplated herein. FIGS. 7A-7D illustrate one possible architecture for the machine-learned model 614. As illustrated in FIG. 7A, the machine-learned model 614 may be a deep ANN that includes three primary sections, in some embodiments. For example, the machine-learned model 614 may include first filter stacks 710, second filter stacks 720, and a third filter stack 730. The first filter stacks may receive the OTDR traces 612, process the OTDR traces 612, and provide a first intermediate output to the second filter stacks 720. The second filter stacks 720 may further process the first intermediate output from the first filter stacks 710 and then provide a second intermediate output to the third filter stack 730. The third filter stack 730 may process the second intermediate output and ultimately provide the set of correction factors 616. Other numbers of sets of filter stacks (e.g., one, two, four, five, six, seven, etc.) are also possible and contemplated herein.

FIG. 7B is a block diagram illustrating the first filter stacks 710 of the machine-learned model 614 shown and described with reference to FIGS. 6A and 7A. As illustrated, the first filter stacks 710 may include multiple filter stacks (e.g., 7 filter stacks in the example of FIG. 7B, each illustrated by a different row of layers) of differing lengths (denoted by the number of layers in each row). For example, three of the filter stacks may include two layers and an activation function, three of the filter stacks may include three layers and two activation functions, and one of the filter stacks may include five layers and four activation functions. Other numbers of filter stacks, other numbers of layers, and/or other numbers of activation functions within each of the filter stacks are also possible and are contemplated herein. Additionally, or alternatively, many of the layers in the first filter stacks 710 may have different kernel sizes (denoted by the k values in the different layers). A “1D Conv” layer is understood to represent a one-dimensional, convolutional ANN layer. Similarly, an M×N value in a layer is understood to represent the channels present in a given convolutional layer. Further, a “ReLU” is understood to represent a rectified linear unit activation function. Additional or alternative activation functions are also possible (e.g., a leaky rectified linear unit activation function (“ReLU”), an exponential linear unit activation function (“ELU”), or a Gaussian error linear unit activation function (“GELU”)).

Each of the filter stacks in the first filter stacks 710 may receive the OTDR traces 612 as an input and generate two intermediate traces as outputs. These intermediate traces (e.g., 14 in total, with 2 for each of 7 filter stacks) may then be concatenated together (e.g., illustrated by the vertical line connecting the stacks at the right edge of FIG. 7B) before being provided to the second filter stacks 720.

Similar to FIG. 7B with the first filter stacks 710, FIG. 7C is a block diagram illustrating the second filter stacks 720 of the machine-learned model 614 shown and described with reference to FIGS. 6A and 7A. As illustrated, the second filter stacks 720 may include multiple filter stacks (e.g., 7 filter stacks in the example of FIG. 7C, each illustrated by a different row of layers) of differing lengths (denoted by the number of layers in each row). For example, three of the filter stacks may include three layers, three of the filter stacks may include five layers, and one of the filter stacks may include nine layers. Other numbers of filter stacks and/or other numbers of layers within each of the filter stacks are also possible and are contemplated herein.

Each of the filter stacks in the second filter stacks 720 may receive the concatenated intermediate trace from the first filter stacks 710 as an input and generate two secondary intermediate traces as outputs. These secondary intermediate traces (e.g., 14 in total, with 2 for each of 7 filter stacks) may then be concatenated together (e.g., illustrated by the vertical line connecting the stacks at the right edge of FIG. 7C) before being provided to the third filter stack 730.

Similar to FIGS. 7B and 7C with the first filter stacks 710 and the second filter stacks 720, FIG. 7D is a block diagram illustrating the third filter stack 730 of the machine-learned model 614 shown and described with reference to FIGS. 6A and 7A. As illustrated, the third filter stack 720 may include five layers. Other numbers of layers are also possible and are contemplated herein.

The third filter stack 730 may receive the second concatenated intermediate trace from the second filter stacks 720 as an input and generate the set of correction factors 616 as an output. As described herein, the set of correction factors 616 may be applied to a mean OTDR trace in order to denoise the mean OTDR trace.

### III. Example Processes

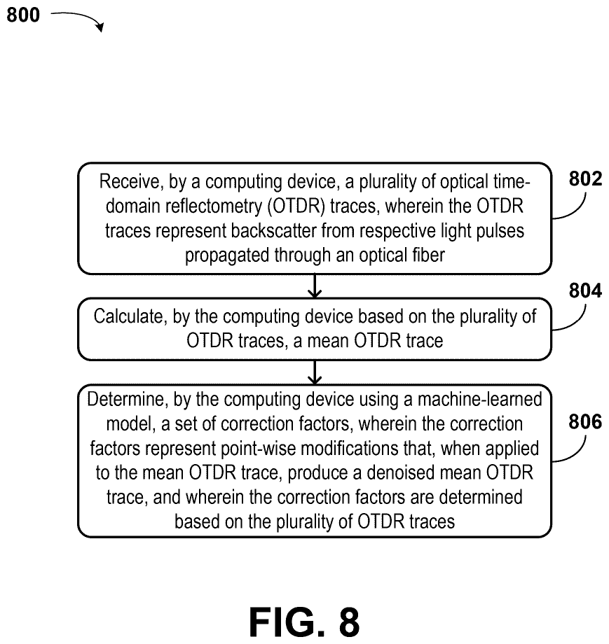

FIG. 8 is a flowchart diagram illustrating a method 800, according to example embodiments. In some embodiments, the method 800 may be performed by a system (e.g., the system 300 shown and described with reference to FIG. 3A).

At block 802, the method 800 may include receiving, by a computing device, a plurality of OTDR traces, wherein the OTDR traces represent backscatter from respective light pulses propagated through an optical fiber.

At block 804, the method 800 may include calculating, by the computing device based on the plurality of OTDR traces, a mean OTDR trace.

At block 806, the method 800 may include determining, by the computing device using a machine-learned model, a set of correction factors, wherein the correction factors represent point-wise modifications that, when applied to the mean OTDR trace, produce a denoised mean OTDR trace, and wherein the correction factors are determined based on the plurality of OTDR traces.

In some embodiments of the method 800, the mean OTDR trace may be calculated using the machine-learned model.

In some embodiments of the method 800, the machine-learned model may include a deep ANN.

In some embodiments of the method 800, block 806 may include applying, by the computing device, the plurality of OTDR traces to a plurality of first filter stacks within the deep ANN to generate a first plurality of intermediate OTDR traces. Block 806 may also include concatenating, by the computing device, the first plurality of intermediate OTDR traces together.

In some embodiments of the method 800, block 806 may include applying, by the computing device, the concatenated first plurality of intermediate OTDR traces to a plurality of second filter stacks within the deep ANN to generate a second plurality of intermediate OTDR traces. Block 806 may also include concatenating, by the computing device, the second plurality of intermediate OTDR traces together.

In some embodiments of the method 800, block 806 may include applying, by the computing device, the concatenated second plurality of intermediate OTDR traces to a third filter stack.

In some embodiments of the method 800, at least two filter stacks of the plurality of first filter stacks may have a different length from one another and/or at least two filter stacks of the plurality of second filter stacks may have a different length from one another.

In some embodiments of the method 800, at least two filters from different filter stacks in the plurality of first filter stacks may have a different kernel size from one another and/or at least two filters from different filter stacks in the plurality of second filter stacks may have a different kernel size from one another.

In some embodiments, the method 800 may also include identifying, by the computing device based on the denoised mean OTDR trace, a malfunctioning fiber splice associated with the optical fiber or a malfunctioning connector associated with the optical fiber. Additionally, the method 800 may include determining, by the computing device based on the denoised mean OTDR trace, a location along the optical fiber of the malfunctioning fiber splice or the malfunctioning connector. Further, the method 800 may include repairing or replacing the malfunctioning fiber splice, the malfunctioning connector, or the optical fiber.

In some embodiments of the method 800, each OTDR trace in the plurality of OTDR traces may include at least 10,000 discrete points, the mean OTDR trace may include at least 10,000 discrete points, and/or pulse widths of the respective light pulses propagated through the optical fiber to generate the plurality of OTDR traces may be each at most 5 ns.

In some embodiments of the method 800, the plurality of OTDR traces may include at least 10 OTDR traces and/or a total duration of each OTDR trace in the plurality of OTDR traces may be at most 1 s.

In some embodiments of the method 800, at least two OTDR traces in the plurality of OTDR traces may have been captured using different sensor gain settings and/or the machine-learned model may be configured to accommodate a plurality of sensor gain settings using a corresponding plurality of scaling factors.

In some embodiments of the method 800, the computing device may be a component of an OTDR device. The OTDR device may include a light detector configured to acquire the plurality of OTDR traces and/or a laser configured to emit light pulses into the optical fiber.

In some embodiments of the method 800, the computing device may be a mobile computing device.

In some embodiments of the method 800, the computing device may be a server device or a cloud computing device.

In some embodiments, the method 800 may also include updating, by the computing device or a separate computing device, the machine-learned model using the plurality of OTDR traces as training data.

In some embodiments of the method 800, the computing device may include a NPU.

In some embodiments of the method 800, the optical fiber may be at least 15 km in length.

### IV. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like ROM, optical or magnetic disks, solid state drives, compact-disc read only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed:

1. A method comprising:
receiving, by a computing device, a plurality of optical time-domain reflectometry (OTDR) traces, wherein the OTDR traces represent backscatter from respective light pulses propagated through an optical fiber;
calculating, by the computing device based on the plurality of OTDR traces, a mean OTDR trace; and
determining, by the computing device using a machine-learned model, a set of correction factors, wherein the correction factors represent point-wise modifications that, when applied to the mean OTDR trace, produce a denoised mean OTDR trace, and wherein the correction factors are determined based on the plurality of OTDR traces.

2. The method of claim 1, wherein the mean OTDR trace is calculated using the machine-learned model.

3. The method of claim 1, wherein the machine-learned model comprises a deep artificial neural network.

4. The method of claim 3, wherein determining the set of correction factors comprises:
applying, by the computing device, the plurality of OTDR traces to a plurality of first filter stacks within the deep artificial neural network to generate a first plurality of intermediate OTDR traces; and
concatenating, by the computing device, the first plurality of intermediate OTDR traces together.

5. The method of claim 4, wherein determining the set of correction factors further comprises:
applying, by the computing device, the concatenated first plurality of intermediate OTDR traces to a plurality of second filter stacks within the deep artificial neural network to generate a second plurality of intermediate OTDR traces; and
concatenating, by the computing device, the second plurality of intermediate OTDR traces together.

6. The method of claim 5, wherein determining the set of correction factors further comprises applying, by the computing device, the concatenated second plurality of intermediate OTDR traces to a third filter stack.

7. The method of claim 5, wherein at least two filter stacks of the plurality of first filter stacks have a different length from one another, and wherein at least two filter stacks of the plurality of second filter stacks have a different length from one another.

8. The method of claim 5, wherein at least two filters from different filter stacks in the plurality of first filter stacks have a different kernel size from one another, and at least two filters from different filter stacks in the plurality of second filter stacks have a different kernel size from one another.

9. The method of claim 1, further comprising:
identifying, by the computing device based on the denoised mean OTDR trace, a malfunctioning fiber splice associated with the optical fiber or a malfunctioning connector associated with the optical fiber;
determining, by the computing device based on the denoised mean OTDR trace, a location along the optical fiber of the malfunctioning fiber splice or the malfunctioning connector; and
repairing or replacing the malfunctioning fiber splice, the malfunctioning connector, or the optical fiber.

10. The method of claim 1, wherein each OTDR trace in the plurality of OTDR traces comprises at least 10,000 discrete points, wherein the mean OTDR trace comprises at least 10,000 discrete points, and wherein pulse widths of the respective light pulses propagated through the optical fiber to generate the plurality of OTDR traces are each at most 5 ns.

11. The method of claim 1, wherein the plurality of OTDR traces comprise at least 10 OTDR traces, and wherein a total duration of each OTDR trace in the plurality of OTDR traces is at most 1 s.

12. The method of claim 1, wherein at least two OTDR traces in the plurality of OTDR traces were captured using different sensor gain settings, and wherein the machine-learned model is configured to accommodate a plurality of sensor gain settings using a corresponding plurality of scaling factors.

13. The method of claim 1, wherein the computing device is a component of an OTDR device, and wherein the OTDR device comprises a light detector configured to acquire the plurality of OTDR traces and a laser configured to emit light pulses into the optical fiber.

14. The method of claim 1, wherein the computing device is a mobile computing device.

15. The method of claim 1, wherein the computing device is a server device or a cloud computing device.

16. The method of claim 1, further comprising updating, by the computing device or a separate computing device, the machine-learned model using the plurality of OTDR traces as training data.

17. The method of claim 1, wherein the computing device comprises a neural processor unit (NPU).

18. The method of claim 1, wherein the optical fiber is at least 15 km in length.

19. An optical time-domain reflectometry (OTDR) device comprising:
a laser configured to emit a series of light pulses into an optical fiber;
a light detector configured to acquire a plurality of OTDR traces, wherein the OTDR traces represent backscatter from respective light pulses of the series of emitted light pulses propagated through the optical fiber; and
a computing device configured to:
receive the plurality of OTDR traces from the light detector;
calculate, based on the plurality of OTDR traces, a mean OTDR trace; and
determine, using a machine-learned model, a set of correction factors, wherein the correction factors represent point-wise modifications that, when applied to the mean OTDR trace, produce a denoised mean OTDR trace, and wherein the correction factors are determined based on the plurality of OTDR traces.

20. A non-transitory, computer-readable medium having instructions stored therein, wherein the instructions, when executed by a processor, perform a method comprising:
receiving a plurality of optical time-domain reflectometry (OTDR) traces, wherein the OTDR traces represent backscatter from respective light pulses propagated through an optical fiber;
calculating, based on the plurality of OTDR traces, a mean OTDR trace; and
determining, using a machine-learned model, a set of correction factors, wherein the correction factors represent point-wise modifications that, when applied to the mean OTDR trace, produce a denoised mean OTDR trace, and wherein the correction factors are determined based on the plurality of OTDR traces.
